(19) United States
(12) Patent Application Publication
(10) Pub. No.: US 2009/0200516 A1
(43) Pub. Date: Aug. 13, 2009

(54) Suppression of flash points of emulsions

(76) Inventors: Charles L. Hawes, Cordova, TN (US); Dennis E. Shireman, Marion, AR (US)

Correspondence Address: BAKER, DONELSON, BEARMAN, CALDWELL & BERKOWITZ;Intellectual Property Department, Monarch Plaza, Suite 1600, 3414 Peachtree Rd., ATLANTA, GA, 30326, US

(21) Appl. No.: 12/069,638

(22) Filed: Feb. 12, 2008

(51) Int. Cl. B01F 17/00

(52) U.S. Cl. 252/364

(57) ABSTRACT

An emulsion composition for cleaning of fresh paint and for thinning of paint, wherein the composition has no observable flash point and comprises a hydrocarbon solvent, a surfactant and water.

### TECHNICAL FIELD

The present invention relates to the suppression of flash points. In a more specific aspect, this invention relates to the suppression of the flash points of emulsion compositions containing a hydrocarbon solvent, a surfactant and water. This invention also relates to a process for suppressing the flash points of these emulsion compositions.

In this application, the term “emulsion” will be understood to refer to a suspension of small globules or droplets of a liquid in a second liquid in which the globules or droplets are not soluble. The emulsion of this application is a macroemulsion in which the liquid globules or droplets (sometimes referred to as the internal phase) are suspended in a second or surrounding liquid (sometimes referred to as the external phase).

### BACKGROUND OF THE INVENTION

Hydrocarbon solvents are well known in the industry for use in compositions for degreasing surfaces, thinning of paint, removal of various spots and stains, for general purpose cleaning, etc.

Typically, the desired qualities of these hydrocarbon solvents have included good solvency, good drying times and the leaving of little or no residue on the surface being treated. However, these qualities tend to result in low flash points, which can lead to concerns in regard to flammability and combustibility, and can also result in high ratings in regard to volatile organic compounds. In addition, being generally derived from crude oil, these solvents are subject to fluctuations in the crude oil market in regard to price and availability.

In the prior art, for example, U.S. Pat. No. 5,230,821 discloses an emulsion cleaning composition which contains a hydrocarbon solvent, and U.S. Pat. No. 5,723,430 discloses a water-containing emulsion cleaner which can contain a hydrocarbon solvent.

There is a need in the industry for an emulsion composition which contains a hydrocarbon solvent and which has a suppressed flash point.

### SUMMARY OF THE INVENTION

The present invention provides an emulsion composition for degreasing surfaces, thinning of paint, removal of various spots and stains and/or general cleaning of fresh paint from tools, equipment and other surfaces involved in a painting process. The emulsion composition of this invention provides one or more advantages not found in the prior art described above, including a suppressed flash point.

The present invention also provides a process for suppressing the flash points of these emulsion compositions.

Briefly described, the present invention provides a new and improved emulsion composition which comprises water, at least one hydrocarbon solvent having a flash point of at least about 140° F. and at least one surfactant.

In this application, the term “flash point” will be understood to refer to the minimum temperature at which the headspace of a material (such as a liquid) is ignited by a small flame under certain standard conditions. Thus, the lower the flash point, the more likely the material can be ignited.

Additionally in this application, the term “paint thinner” or “thinning of paint” will be understood to refer to an emulsion composition which does not substantially affect other physical and chemical properties of the paint before and after curing. Examples of such properties are color, gloss, hardness, reactability and dispersability.

Paint thinners must also be effective in cleaning tools, equipment and other surfaces which are soiled by fresh uncured paint during a painting project. A paint thinner is especially useful with fresh uncured paint, but not with hardened cured paint where a paint remover or paint stripper would be required.

In thinning paint, the paint thinner is poured into the paint and then mixed (i.e., with stirring, agitation, etc.) until a substantially homogeneous mixture is obtained having a lower viscosity (compared to the original paint being thinned). The emulsion compositions of this invention will effectively thin paint and will also maintain other physical and chemical properties of the paint. The emulsion compositions of this invention will not adversely affect those properties and will not cause problems in paint application or defects in the painted surface which are due to the thinned paint.

Accordingly, an object of this invention is to provide an emulsion composition.

Another object of this invention is to provide an emulsion composition that has good cleaning and paint thinning properties.

Another object of this invention is to provide an emulsion composition having no observable flash point.

Still another object of this invention is to provide a process for cleaning of fresh paint with an emulsion composition.

Still another object of this invention is to provide a process for thinning paint with an emulsion composition.

Still another object of this invention is to provide a process for using an emulsion composition having no observable flash point.

These and other objects, features and advantages of the present invention will become apparent from the following description.

### DETAILED DESCRIPTION OF THE INVENTION

The present invention provides a composition, in the form of an emulsion, having no observable flash point and comprising water, a hydrocarbon solvent and a surfactant. This composition is useful for cleaning of fresh paint and for thinning of paint. This invention also provides a process for the use of such an emulsion composition.

In this application, the terms “high flash point” and “no observable flash point” will be understood to refer to an emulsion composition which will not ignite or produce a flash (testing done in accordance with the procedure set forth in ASTM D3828-07A) at temperatures up to the boiling point of the composition.

In addition, the emulsion compositions of this invention have surprisingly been found to not burn under ordinary conditions and may actually be useful in quenching materials that are burning.

The emulsion composition of this invention has certain essential components. These components and their corresponding weight percent ranges are shown below, with the weight percents being based on the total weight of the composition.

| Component | Weight Percent Range |
|---|---|
| Hydrocarbon Solvent | about 15.0 to about 65.0 |
| | (preferably about 20.0 to about 50.0) |
| Surfactant | about 0.10 to about 5.0 |
| | (preferably less than about 1.0) |
| Water | about 35.0 to about 85.0 |
| | (preferably about 50.0 to about 75.0) |

If these components are used in amounts outside these ranges, the emulsion composition may provide results which do not meet the user's objectives in regard to thinning paint, cleanup of fresh paint, flash point suppression, no adverse effect on paint properties, dry time, flow and leveling, etc. The emulsion compositions of this invention do not leave a noticeable residue on the painted surface and do not interfere with adhesion of the thinned paint and/or subsequent coats of paint on the surface.

Optional components may be added to the composition of this invention to achieve other objectives. Examples of these optional components are builders, preservatives, colorants, evaporation retardants, humectants, anti-settling agents, pigments, bittering agents, pH adjusting agents, etc. These optional components can be used in the amounts necessary to achieve desired results.

Examples of suitable hydrocarbon solvents are aliphatic and aromatic hydrocarbons, including hydrocarbon solvents having flash points of about 160° F.-170° F. Other useful hydrocarbon solvents are well known in the industry. Mixtures of these hydrocarbon solvents can be used.

Examples of suitable aliphatic and aromatic hydrocarbon solvents include kerosene, naptha, aromatic napthas and aliphatic napthas.

Preferred hydrocarbon solvents include solvents consisting essentially of C10- C₁₂ saturated hydrocarbons and having a flash point of at least about 140° F. (such as available from Citgo Chemicals under the trademark CITGO 150); solvents which are essentially a mixture of hydrotreated isoparaffins and naphthenics and having a flash point of at least about 140° F. (such as available from Solvay Chemical Company under the trademarks Vista LPA-142 and Vista LPA-170); and solvents consisting essentially of alkylated benzenes and alkylated naphthalenes and having a flash point of at least about 140° F. (such as available from Exxon Chemical Company under the trademark Aromatic 150).

The surfactant functions as a stabilizer to produce the emulsion and then to prevent separation of the emulsion into various components. Examples of suitable surfactants are nonionic surfactants, cationic surfactants, anionic surfactants, amphoteric surfactants and mixtures of such surfactants.

Examples of suitable nonionic surfactants are:
alkoxylated alkyl phenols;
alkoxylated alcohols;
amines;
amides;
alkoxylated amides;
alkoxylated amines;
alkoxylated fatty acids;
alkoxylated thioethers;
glycerol esters;
sorbitan and alkoxylated sorbitan esters;
polygluconates;
silicone surfactants;
polymeric nonionic surfactants; and
ethylene oxide/propylene oxide block copolymers.

Examples of suitable cationic surfactants are:

alkyl trimethylammonium chlorides and bromides having from 12 to 22 carbon atoms and alkoxylated derivatives thereof;

dialkyl dimethylammonium chlorides and bromides having from 12 to 22 carbon atoms and alkoxylated derivatives thereof;

alkyl amine hydrochlorides and hydrobromides;

sulfates and sulfonates having from 12 to 22 carbon atoms and alkoxylated derivates thereof.

Examples of suitable anionic surfactants are:

acids and salts of alkyl sulfates and alkyl ether sulfates having from 12 to 30 carbon atoms;

acids and salts of alkylbenzene sulfonates having from 12 to 30 carbon atoms;

acids and salts of alkyldiphenyl oxides, sulfonates and disulfonates having from 12 to 30 carbon atoms;

acids and salts of alkyl naphthalene sulfonates having from 12 to 30 carbon atoms;

acids and salts of alkane or olefin sulfonates having from 10 to 20 carbon atoms;

acids and salts of ester sulfonates having from 12 to 20 carbon atoms;

acids and salts or various half salts of alkyl sulfosuccinates;

acids and salts of sulfobetaines;

acids and salts of phosphate esters;

acids and salts of saturated and unsaturated fatty acids having from 10 to 24 carbon atoms;

acids and salts of taurates and isothionates having from 12 to 24 carbon atoms.

Example of suitable amphoteric surfactants are:

amine oxides and betaines having from 10 to 20 carbon atoms;

alkyl imidazolines and imidazoline derivatives having from 10 to 24 carbon atoms;

acids and salts of alkylpropionates having from 10 to 24 carbon atoms;

acids and salts of alpha and beta alkyl aminoacid derivatives having from 10 to 24 carbon atoms;

alkyl substituted nitrogen heterocyclics having from 10 to 24 carbon atoms.

The water used in the composition of this invention can be deionized, soft, hard, sea water, tap, potable and non-potable water. Mixtures of such waters can be used.

The present invention is further illustrated by the following examples which are designed to teach those of ordinary skill in the art how to practice this invention and to represent the best mode contemplated for carrying out this invention.

### EXAMPLES 1-3

In Examples 1-3, the emulsion compositions were prepared by mixing a hydrocarbon solvent, water and a surfactant in the amounts as described below. These emulsion compositions were then tested at the indicated temperatures (starting with the lowest temperature) to determine the flash point of the emulsion composition. For comparison purposes, compositions of 100% solvent (no water) and 100% water (no solvent) were also heated to determine the flash point of those compositions.

Except for the compositions of 100% solvent and 100% water, each composition of Examples 1-3 also contained 0.75 weight percent of the surfactant oleyl imidazoline, which is available from Uniqema Corporation under the trademark Monazoline O.

In Examples 1-3, the amount of solvent in the compositions is shown in Charts No. 1-3, respectively. Except for the amount of surfactant present (0.75 weight percent), the remainder of each composition is water. The flash point results for Examples 1-3 are shown in Charts No. 1-3, respectively. Only Examples 2-3 are within the scope of this invention.

In Example 1 and Chart No. 1—The solvent is regular mineral spirits. The letter “A” designates the area in which the composition exhibits a flash point, as expected. The letter “B” designates the area in which the composition exhibits, as expected, no flash point below the flash point of the solvent.

In Example 2 and Chart No. 2—The solvent is Vista LPA 142 solvent. The letter “A” designates the area in which the composition exhibits a flash point, as expected. The letter “B” designates the area in which the composition surprisingly exhibits no observable flash point. The letter “C” designates the area in which the composition exhibits, as expected, no flash point below the flash point of the solvent. In Example 3 and Chart No. 3—The solvent is CITGO 150 solvent. The letter “A” designates the area in which the composition exhibits a flash point, as expected. The letter “B” designates the area in which the composition surprisingly exhibits no observable flash point. The letter “C” designates the area in which the composition exhibits, as expected, no flash point below the flash point of the solvent.

Examples 2 and 3 (emulsion compositions within the scope of this invention) show no observable flash point up to the boiling point of each composition. Example 1 (an emulsion composition not within the scope of this invention) shows an observable flash point. The testing for Examples 1-3 was conducted as described in the ASTM D3828-07A procedure.

### EXAMPLE 4

The emulsion composition of Example 2 of this application shows a substantially less likelihood to provide fuel to the fire.

A test (Commodity Classification Test in accordance with the NFPA 13 procedure conducted by Underwriters Labs) was conducted in which eight pallets of the emulsion composition(Example 2) were placed in a 2×2×2 pallet arrangement on a warehouse rack with several sprinklers having different spray densities located above the rack. The rack was ignited, which caused the wood, cardboard and plastic shrink wrap to burn. The emulsion composition did not support combustion, but did help the sprinkler system extinguish the fire. As a result of this action, the emulsion composition achieved a Commodity Classification of 1, which is the lowest classification possible for this type of commodity and which is comparable to bottled water.

The present invention has been described in detail with particular reference to certain embodiments, but variations and modifications can be made without departing from the spirit and scope of the invention as defined in the following claims.

1. An emulsion composition comprising:
A. from about 35.0 to about 85.0 percent by weight of water;
B. from about 15.0 to about 65.0 percent by weight of at least one hydrocarbon solvent having a flash point of at least about 140° F.; and
C. from about 0.10 to about 5.0 percent by weight of at least one surfactant; wherein the emulsion composition has no observable flash point at temperatures up to the boiling point of the composition.

2. A composition as defined by claim 1 wherein the composition comprises from about 20.0 to about 50.0 percent by weight of the hydrocarbon solvent.

3. A composition as defined by claim 1 wherein the composition comprises from about 50.0 to about 75.0 percent by weight of water.

4. A composition as defined by claim 1 wherein the composition comprises less than about 1.0 percent by weight of the surfactant.

5. A composition as defined by claim 1 wherein the hydrocarbon solvent is an aliphatic hydrocarbon.

6. A composition as defined by claim 1 wherein the hydrocarbon solvent is an aromatic hydrocarbon.

7. A composition as defined by claim 1 wherein the surfactant is an anionic, nonionic, cationic, amphoteric or quaternary surfactant or a mixture of such surfactants.

8. A composition as defined by claim 1 wherein the surfactant is an amphoteric surfactant.

9. A composition as defined by claim 7 wherein the amphoteric surfactant is oleyl imidazoline.

10. A composition as defined by claim 1 wherein the water is deionized or tap water.

11. A process for thinning paint, wherein the process comprises treating the paint with an emulsion composition comprising:
A. from about 35.0 to about 85.0 percent by weight of water;
B. from about 15.0 to about 65.0 percent by weight of at least one hydrocarbon solvent having a flash point of at least about 140° F.; and
C. from about 0.10 to about 5.0 percent by weight of at least one surfactant;
wherein the emulsion composition has no observable flash point at temperatures up to the boiling point of the composition.

12. A process as defined by claim 11 wherein the composition comprises from about 20.0 to about 50.0 percent by weight of the hydrocarbon solvent.

13. A process as defined by claim 11 wherein the composition comprises from about 50.0 to about 75.0 percent by weight of water.

14. A process as defined by claim 11 wherein the composition comprises less than about 1.0 percent by weight of the surfactant.

15. A process as defined by claim 11 wherein the hydrocarbon solvent is an aliphatic hydrocarbon.

16. A process as defined by claim 11 wherein the hydrocarbon solvent is an aromatic hydrocarbon.

17. A process as defined by claim 11 wherein the surfactant is an anionic, nonionic, cationic, amphoteric or quaternary surfactant or a mixture of such surfactants.

18. A process as defined by claim 11 wherein the surfactant is an amphoteric surfactant.

19. A process as defined by claim 18 wherein the amphoteric surfactant is oleyl imidazoline.

20. A process as defined by claim 11 wherein the water is deionized or tap water.
